(19) United States
(12) Patent Application Publication
(10) Pub. No.: US 2012/0310763 A1
(43) Pub. Date: Dec. 6, 2012

(54) SYSTEM AND METHODS FOR MATCHING POTENTIAL BUYERS AND SELLERS OF COMPLEX OFFERS

(76) Inventor: Michael Meehan, Lafayette, CA (US)

(21) Appl. No.: 13/181,471

(22) Filed: Jul. 12, 2011

Related U.S. Application Data
(60) Provisional application No. 61/520,247, filed on Jun. 6, 2011.
(60) Provisional application No. 61/498,509, filed on Jun. 17, 2011.

(51) Int. Cl. G06Q 30/00

(52) U.S. Cl. 705/26.2

(57) ABSTRACT

A system for matching potential buyers and sellers of complex offers, comprising a plurality of data collection devices, each connected to at least one packet-based data network and adapted to collect data pertaining to a plurality of potential buyers or sellers of complex offers, a summary data generator software module operating on a server computer and connected via a data network to a database, an attribute index generator software module operating on a server computer and connected via a data network to the database, a categorization software module operating on a server computer and connected via a data network to the database, a buyer analysis engine software module operating on a server computer and connected via a data network to the database, an analysis engine software module operating on a server computer and connected via a data network to the database, and a matching engine software module operating on a server computer and connected via a data network to the database. Data collected by the data collection devices is stored in the database and is used by the summary data generator software module to generate a plurality of summary data elements pertaining to a potential buyer of a complex offer, and the plurality of summary data elements is stored in the database and used by the attribute index generator software module to generate attribute indices each based on at least two summary data elements using a weighted relational algorithm, and at least some data collected by the data collection devices is used by the buyer analysis engine software module to determine at least a probability that a buyer will buy a specific complex offer, and the marching engine software module uses an optimization algorithm to determine an optimal matching of potential buyers and complex offers based at least in part on a plurality of attribute indices and a likelihood to buy for each potential pair of offers and potential buyers.

### CROSS-REFERENCE TO RELATED APPLICATIONS

The present invention claims priority to provisional applications, Ser. Nos. 61/520,247 titled “System and Methods for Matching Potential Buyers and Sellers of Complex Offers,” and 61/498,509, titled “System and Method for Applying Weighted Relational Transformation to a Data Set,” filed on Jun. 6, 2011 and Jun. 17, 2011, respectively. The disclosure of each of the above-referenced patent applications is hereby incorporated by reference in its entirety.

### BACKGROUND OF THE INVENTION

1. Field of the Invention

The present invention is in the field of ecommerce and Internet-enabled business, and more particularly to the field of facilitating the matching of buyers and sellers of complex products and services.

2. Discussion of the State of the Art

In general, it is difficult for buyers and sellers of complex products and services to identify each other and to meaningfully share information that facilitates value exchange. In some cases, the existence of a small number of well-known producers of a category of complex product reduces this problem. For example, when an airline seeks to buy large jets for a new route or to replace aging jets, there are only two main vendors currently. However, there exist markets where there are many suppliers and many potential customers, but where the products and services are complex and must satisfy equally complex (and often rapidly changing) needs.

One example of such a market, which is used for illustrative purposes in this application, is the market for products and services targeted at helping enterprises become more sustainable. The market for sustainability solutions (products, services, or both together) is relatively young (although may products sold within it are not; as the category emerged, products originally sold for other purposes became repurposed as sustainability products), and highly fragmented. Moreover, customer demand for sustainability products and services varies widely and is frequently changing. Some enterprises have made sustainability a primary corporate value, whereas others do not even think of sustainability as a valid topic (but may nevertheless be interested in reducing their energy expenditures). Complicating matters, “sustainability” is an umbrella concept that covers many ideas, and many product and services categories, from energy management software, to alternative waste disposal services, to carbon tracking and accounting products.

It is an object of the present invention to enable buyers to identify and compare complex products, and to allow sellers to identify potential buyers of complex products and services, and to provide an intelligent means for matching buyers and sellers of complex products and services.

### SUMMARY OF THE INVENTION

According to a preferred embodiment of the invention, a system for matching potential buyers and sellers of complex offers, comprising a plurality of data collection devices, each connected to at least one packet-based data network and adapted to collect data pertaining to a plurality of potential buyers or sellers of complex offers, a summary data generator software module operating on a server computer and connected via a data network to a database, an attribute index generator software module operating on a server computer and connected via a data network to the database, a categorization software module operating on a server computer and connected via a data network to the database, a buyer analysis engine software module operating on a server computer and connected via a data network to the database, an analysis engine software module operating on a server computer and connected via a data network to the database, and a matching engine software module operating on a server computer and connected via a data network to the database is disclosed. According to the embodiment, data collected by the data collection devices is stored in the database and is used by the summary data generator software module to generate a plurality of summary data elements pertaining to a potential buyer of a complex offer, and the plurality of summary data elements is stored in the database and used by the attribute index generator software module to generate attribute indices each based on at least two summary data elements using a weighted relational algorithm, and at least some data collected by the data collection devices is used by the buyer analysis engine software module to determine at least a probability that a buyer will buy a specific complex offer, and the marching engine software module uses an optimization algorithm to determine an optimal matching of potential buyers and complex offers based at least in part on a plurality of attribute indices and a likelihood to buy for each potential pair of offers and potential buyers.

### BRIEF DESCRIPTION OF THE DRAWING FIGURES

FIG. 1 is a block diagram of components of the invention in one embodiment, highlighting different roles played in carrying out the invention.

FIG. 2 is a process flow diagram of an overall method of the present invention.

FIG. 3 is a process flow diagram of a method for automatically collecting and analyzing data to determine indices reflecting underlying attributes of a business, according to the invention.

FIG. 4 is a process flow diagram of a method of summarizing detailed data about a business into a plurality of binary attributes, according to the invention.

FIG. 5 is a process flow diagram of a method for dynamically creating weighted relational transformation that, operating on summary data, creates one or more indices tied to particular high-level business attributes, according to the invention.

FIG. 6 is a process flow diagram of a method of determining a likelihood to buy based on weighted relational transforms of summary data, according to the invention.

FIG. 7 is a process flow diagram of a method of matching potential buyers and capable sellers for particular categories of products or services, according to the invention.

FIG. 8 is an illustration of a dashboard page of a user interface according to an embodiment of the invention.

FIG. 9 is an illustration of a solution statistics page of a user interface according to an embodiment of the invention.

FIG. 10 is an illustration of a products page of a user interface according to an embodiment of the invention.

FIG. 11 is an illustration of a sales opportunities tab of a page of a user interface according to an embodiment of the invention.

FIG. 12 is an illustration of a products tab of a page of a user interface according to an embodiment of the invention.

FIG. 13 is an illustration of a gap analysis tab of a page of a user interface according to an embodiment of the invention.

FIG. 14 is an illustration of a “red herrings” tab of a page of a user interface according to an embodiment of the invention.

FIG. 15 is an illustration of a corporate sustainability survey page of a user interface according to an embodiment of the invention.

FIG. 16 is an illustration of a sustainability action portal page of a user interface according to an embodiment of the invention.

### DETAILED DESCRIPTION

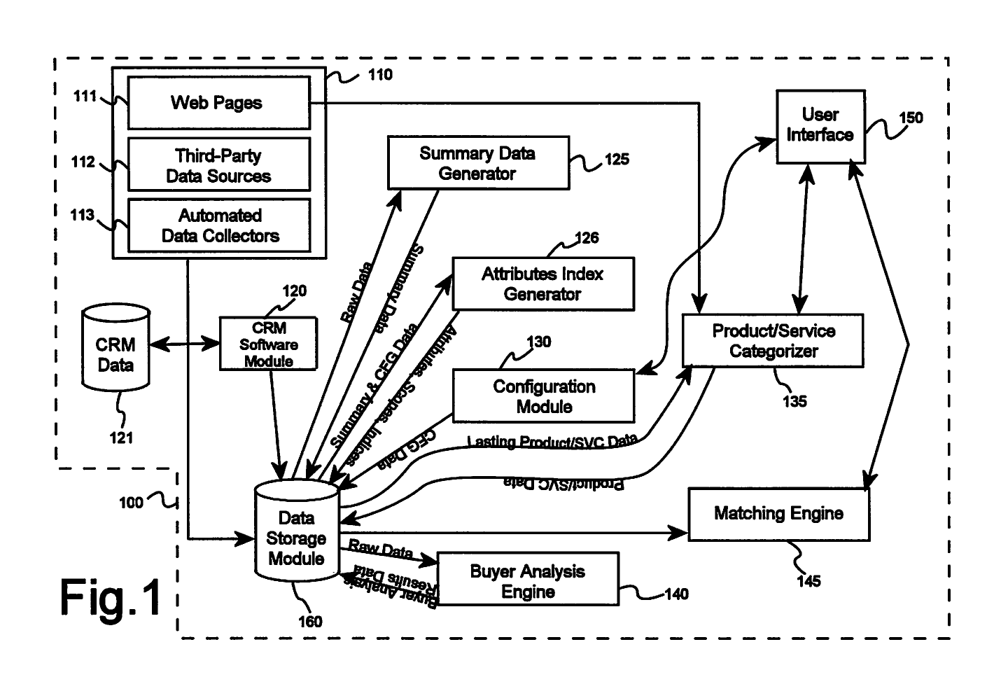

The inventors provide, in one embodiment, a system for matching potential buyers and sellers of complex products and services. In FIG. 1, various data collection modules 110 are used to collect a wide range of data about potential buyers and sellers. Data collected can include, but is not limited to, information about sustainability initiatives underway, corporate attitudes towards sustainability, current use of sustainability and related products and services, open requests for proposal (RFPs), and so forth—on the buyers' side—and current and projected sustainability-related products and services, case studies, pricing information, and the like—from the sellers' side. It should be appreciated that obtaining a wide range of information is desirable in order to facilitate the determination, according to the invention, of relevant needs and likelihood to buy, on the buyers' side, and similarly to facilitate the determination of the complete range of current and projected products and services that may be relevant to sustainability initiatives, on the sellers' side, is clearly desirable. Similarly, gathering information pertaining to needs and available products and services in other areas than sustainability—which is used herein as a preferred embodiment, but which does not define the scope of the invention, which could be used to advantage with respect to other categories of products or services—would clearly be of value to both buyers and sellers. Buyers generally have at best grossly incomplete data about the range of products and services that are available in the marketplace to meet any given need (such as for a sustainability solution), and sellers often have large and complex product and service offerings which often are designed around one market or need but could be applicable to others.

Data is sometimes collected directly from users via a plurality of web pages 111, for example when a potential buyer fills out a survey discussing her potential needs in a particular area such as sustainability products and services. In some cases dedicated web pages are provided, for example on a corporate intranet, to facilitate the collection of relevant data from individuals who possess it. For example, a product manager could use a web page to enter information concerning the sustainability benefits of products under her management, or a director of sustainability could use a purpose-built web page to enter information pertaining to sustainability initiatives contained within the current or next year's budget. In other cases, data entered on web pages may be entered for other purposes but also collected for use according to the present invention. For example, in some embodiments when a web page is used to enter a purchase order within a corporation, a copy of the data entered is collected and sent to data storage module 160 for use in determining, for example, what sustainability products and services have already been purchased by the corporation. It will be evident that a wide range of information can readily be collected, given the pervasive use of browser-based business applications within corporations, from interactions of users and web pages, whether the pages are specifically for collecting information for use according to the invention or the pages are designed for other uses and the information collected by them is “harvested” for use according to the invention, possibly without a users' awareness.

In some embodiments, data is collected automatically from third-party data sources 112, for example via bulk download of data from non-governmental organizations such as the Carbon Data Project (CDP). It should be well understood by one having ordinary skill in the art of data collection via the web that there are many well-established means of collecting data from third-party computer systems, such as web services, file transfer protocol, secure file transfer protocol, and the like. Additionally, in some embodiments, automated data collectors 113 “crawl” the web or other data repositories and apply heuristics or other rules to discriminate relevant data from the much larger quantity of irrelevant data. For example, a crawler 113 could be used that automatically revisits the web sites of all companies and organizations within a certain geography, industry, size range, or market category (for instance, publicly traded companies), in order to seek out new press releases and other materials that might have information pertaining to an individual company's or industry's adoption of sustainability-based initiatives or purchase of sustainability products and services. Relevant data could be identified by, for example, scanning text for occurrences of particular keywords or groups of keywords, particularly if the groups of keywords are located close together. According to an embodiment of the invention, another example of a crawler 113 utilizes a search engine advantageously to find difficult-to-locate information sources relevant to the task at hand (that is, according to the embodiment, relevant to determining needs for sustainability products and services, or likelihood to purchase such products and services, or availability of relevant sustainability products and services from a particular potential seller). According to the embodiment, one or more keywords may be entered into a publicly available search engine (or an enterprise search engine that searches only sources internal to an enterprise), and a resulting set (potentially large) of relevance-ranked links returned. These links, which represent a targeted subset of the Web that contain at least the entered search terms within their content or metadata, can then be traversed by crawler 113 and inspected to determine whether any relevant data is present (and if so, relevant data is collected, possibly transformed for example into a standard format such as extensible markup language or XML, and sent to data storage module 160). It will be understood by one having ordinary skill in the art of web crawler/spider design that it is straightforward to broaden the search for relevant data by selectively (or randomly, or completely) following links contained in the content linked to by the original search results; this process of examining a linked-to page of content for relevance and then following one or more links on the page to get yet another possibly relevant content page can clearly cover quite a lot of “ground” (given the normally high degree of interlinkages within the Web). According to some embodiments, one or more means for limiting and focusing the search for relevant data is employed. For instance, whether to follow links contained within a given content page can be determined based on the degree of relevance of the content within the page (that is, if the page is highly relevant, then its links will be checked as well, while if the page was found to be completely irrelevant, its links will be ignored and the page will be a truncation point for the overall search strategy). In other embodiments, some portion of links on each page (all, the first n links, any links containing at least one of the original search or a random set of links) is always inspected, but the search is limited in depth; that is, links will be followed only to a depth of, for example, four—meaning a search result link (1), a page linked to within the search result link (2), a page linked to within the second page (3), and finally a page linked to within the third page (4), with all links on the fourth page ignored.

Generally data collected by a plurality of data collectors 110 is sent to and stored in data storage module 160. Data can also optionally be collected in batch or continuous (or event-driven) mode from a customer relationship management (CRM) software module 120, which provides secure access to CRM data 121 to applications such as those of the present invention. For example, customer lists and lead lists are common data sets contained with CRM data 121, and accessible via CRM software module 120. Moreover, in some embodiments complex query-like requests are made to CRM software module 120 to obtain specific relevant data from CRM data 121, for instance by requesting a list of all clients (of a given corporation whose CRM system 120 is being queried) that have purchased a particular type of smart meter to monitor electricity usage in their facilities, said list being used as a set of relevant data useful in other modules of the invention for determining potential buyers who are making energy-aware purchase decisions.

Data store 160 is in a preferred embodiment a relational database management system (RDBMS), such as those available from Oracle™ or Microsoft™. While relational databases are expected to be commonly used in embodiments of the invention, the invention is not limited in any way to the form of data store 160 selected. For example, a Hadoop file system suitable for large-scale, widely-distributed data storage, could be used, or a column-oriented or in-memory database system (relational or otherwise) could be used. In some cases, clustered database technology (well-known in the art) is used to allow for very scalable embodiments of the invention. Accordingly, it should be apparent to one having ordinary skill in the art that any of the many competing forms of large-scale data storage can be used according to the invention, without loss of generality.

According to the preferred embodiment, raw data is sent from data storage module 160 to summary data generator 125, a software module operating on one or more general-purpose computers. Data can sent periodically, or via a publish-and-subscribe model, or only when specifically requested (that is, in what is known in the art as “pull mode”), or indeed according to any of a number of alternative means of getting data from a storage system 160 to a software module that uses the data (in this case summary data generator 125); it should be appreciated that, in this connection as well as in all others described herein, the format and means of passing data from one software module to another is not important, and any of the many techniques well-established in the art of networked software system design can be used according to the invention. More particulalry, all of the software modules described herein are assumed to be adapted to communicate via one or more packet-based data networks such as a local area network (LAN), wide area network (WAN), metropolitan area network (MAN) or the Internet. Techniques of interprocess communications across packet-based data networks are well established in the art and are not described herein.

Summary data generator 125 applies rules and heuristics to raw data obtained from data storage module 160 to generate a large number of summary data elements, which are then passed to data storage module 160 for storage and later use. Summary data is comprised of binary data elements representing answering to yes/no questions such as “does this company use energy management software?” Alternatively, summary data can also comprise numerical data, such as an amount spent over the last year on sustainability projects, either as an absolute amount or as a percentage of revenue. As an example of summary data generation, a heuristic is defined which states “companies that have bought at least three products from within the category of ‘smart grid’ within the last three quarters are considered to have a smart grid initiative”. Companies which are found to satisfy this rule (by having bought—based on data obtained from data collectors 110—at least three products categorized as “smart grid” products within the last six months are tagged with a TRUE value in the summary data element “Company has an active smart grid initiative”; it should be understood that this heuristic is only one of many possible ones, and in some cases other heuristics may suggest a different answer. For instance, a sustainability executive may have verbally told a salesman of a product vendor that “We started a smart grid initiative but abandoned it, and no longer have budget”; in this case, the salesman may have entered data on a web page 111 following an interview in which the executive made the statement in question, the data indicating that the company did not, in fact, have an active smart grid initiative in place. Additional heuristics or rules may be used, according to the invention, to resolve conflicts between other heuristics. For example, in this case a rule might be in place that states that more credence will be given to statements made by sustainability executives than to inferences drawn from public product purchase data, and the conclusion might be (based on the two rules described in this example) that the value of “Company has an active smart grid initiative” should be set to FALSE. Rules and heuristics used by summary data generator 125 are one of several sets of configuration data that are managed by users through configuration module 130 and stored in data storage module 160. Along with raw data, summary data generator retrieves (on startup, and periodically thereafter, and also when changes are made which trigger automatic notification) configuration data from data storage module 160 and uses this configuration data to drive its creation and assignment of values to summary data elements. Note that, in some embodiments, configuration module 130 is connected via a network directly to summary data generator 125 (and indeed to other consumers of configuration data), in order to allow direct queries of configuration data from configuration module 130 by summary data generator 125, and indeed any software module within system 100 may be connected directly to configuration module 130 or may consume configuration data only via data storage module 160. Again, there are many variations of configuration management that are well-known in the art of networked software system design, and any of these may be used according to the invention. Once summary data is created (or updated), it is passed to data storage module 160 for retention and for delivery to software modules that use the summary data.

Summary data is obtained from data storage module 160 by attribute index generator 126, a software module that applies a set of configurable weighted relational algorithms to various subsets of summary data to produce a plurality of high-level indices that correspond to a company's or organization's level of need for a particular category of sustainability product or service. Examples of sustainability indices according to embodiments of the invention include a “energy management index”, a “carbon management index”, a “smart grid solutions index”, an “environmental services index”, a “financial services index”, a “facility management technology index”, and a “basic sustainability index”. It will be appreciated that these are merely exemplary, and that the methods outlined herein and in the drawings could be used, for example, to provide sophisticated assessments of the needs of a particular company for various types of insurance products and services.

Attribute indices are generated by attribute index generator 126 from summary data obtained from data storage module 160, according to a preferred embodiment of the invention, using a configurable weighted relational algorithm. Configuration is accomplished using configuration module 130, and configuration data is either stored in data storage module 160 or delivered directly from configuration module 130 to attribute index generator 126, as described above. Configuration data specifies, among other things, which summary data elements are used, in what combinations and accorded what relative weights, to generate each particular attribute index. Also, relational rules are specified as configuration data. A relational rule is a rule that describes the relationships between different sets of summary data, particularly as they are used to generate attribute indices. For example, in one embodiment an ISIS Energy Management Index is computed for potential buyers, the index being a measure of need of that particular potential buyer for energy management products and services. According to the exemplary embodiment, two or more distinct configurable rules are established. One rule might specify that if summary data indicates a particular company has untracked energy usage and has an energy management system in place, then the company should receive a low score on the ISIS Energy Management Index, while if a another company has untracked energy usage and does not have an energy management system in place, then that company would receive a high score on the ISIS Energy Management Index (indicating a high level of need for energy management solutions). Thus the first example company would not be considered a likely prospect for a product that delivers energy management features, whereas the second company would be considered a likely prospect for a product that delivers energy management features, even though both have an identical score (TRUE) on the summary data element “has untracked energy usage”. This example illustrates a relational aspect of the invention's algorithm for determining attribute indices (in attribute index generator 126). Additionally, each rule or heuristic may specify different weights to be applied to each different summary data element when it is used as an input, with any particular summary data element potentially having many different weights used, depending on the rule being used, and depending on which attribute index was being generated. For example, “has energy management solution in place” might be accorded a very high weight when determining an energy management index, but it might be accorded a lower weight when computing an overall sustainability index (since energy management is only a small part of the overall sustainability challenge businesses face). Thus attribute index generator 126 uses a weighted relational algorithm to determine its results, and all weights and relationships are determined by configuration data typically created and maintained by users of configuration module 130.

Product/service categorizer 135 obtains data from data collectors 110, including but not limited to web pages 111 where users (typically product managers) enter data pertaining to a variety of products and services. Additional data may be obtained from third party sources 112 and automated data collectors 113; in many embodiments, some or all such data is obtained directly from data storage module 160, although in some embodiments data is collected directly from source systems such as data collectors 110. Product/service categorizer 135 applies configurable rules (again, configured using configuration module 130) to categorize each subject product or service. Categories generally (although not exclusively or necessarily) correlate with the subjects of the plurality of attribute indices computed by attribute index generator 126. For example, an ISIS Energy Management Index measures demand, within a given company (or indeed a given group of companies or even an industry; according to the invention, attribute indices may be computed for any combination of entities), for energy management products and services, and a corresponding energy management category is among the categories that may be used by product/service categorizer 135 (again, as noted above, it is important to recognize that sustainability and related categories such as energy management and smart grid are merely examples of a preferred embodiment of the invention, which can be used readily to classify and determine need for, for example, complex insurance and banking products). There is not necessarily, or even generally, a one-to-one correspondence between products/services and categories. Many products, such as a smart meter, might easily be assigned to more than one category (in this case, smart meters might be assigned to “energy management”, “smart grid”, and “general sustainability”). While in most embodiments assignment of categories is performed automatically by product/service categorizer 135, according to configurable rules, in some embodiments human categorization is also used, either to supplement, correct, or replace automatic categorization. In some cases, where automatic rules do not enable product/service categorizer 135 cannot generate a relevant categorization for a given product or service, an alert may be generated to trigger a review, using user interface 150, by a human to determine if there exist one or more categories to which the subject product or service could be assigned.

More generally, user interface 150 provides a means for human users to interact with various software modules of the invention. For instance, a user can use user interface 150 to review, change, add, delete, or approve configuration rules (in some embodiments, certain users generate candidate rules and categorizations, and other users review and approve those decisions, both using user interface 150). As just described, users may interact with product/service categorizer 135 to add, modify, or delete product and service categorizations that might have been generated automatically (by product/service categorizer 135 or by another user). User interface 150 is, in a preferred embodiment, a dedicated set of web pages designed for interaction with a system according to the invention, although in other embodiments user interface 150 is a dedicated desktop computer software application or a mobile device application.

Buyer analysis engine 140 is similar in many regards to attribute index generator 126 and product/service categorizer 135, in that a large amount of raw data, obtained either from data storage module 160 or directly from one or more of data collectors 110, is used in conjunction with a set of configurable rules (managed again by configuration module 130 and stored in data storage module 160 or delivered directly to buyer analysis engine 140 from configuration module 130), to generate a further set of attributes of specific potential buyers of a given category of products or services. Attributes computed include various aspects of a basic attribute—likelihood to buy. For example, if a company that may have a high ISIS Sustainability Index, indicating a high need for a broad range of sustainability products and services, it does not always follow that they are likely to buy such products or services, because other issues pertaining to readiness or likelihood to buy may come into play. To make this clear, consider a typical consumer, who might have a strong “need” for a luxury car, but no budget for a new car purchase. This would be an example of someone with a high “needs index” but a low “likelihood to buy” attribute. In the corporate world, many factors can come into play, and can be considered by buyer analysis engine 140. Common likelihood to buy indicators include whether budget has actually been allocated for a given initiative, whether executive support exists, whether the category initiatives being considered are in an appropriate stage (stages might include, for example: concept exploration, feasibility study, budget/business case development, request for proposal preparation or evaluation, pilot program, purchase, or scale up). Some stages in a high-level initiative lifecycle are strongly associated with buying behavior (request for proposal, pilot, scale up), whereas others are associated with early research (concept exploration, feasibility study), and yet others may be associated with a marked negative likelihood to buy (failed pilot, strategy change away from category, strong initiative elsewhere competing for attention and dollars). A key purpose of buyer analysis engine 140 is to identify those potential buyers that are very likely to buy in the near term (hot prospects), those that are likely to buy, but over a longer term (warm prospects), those that have low likelihood to buy in the foreseeable future (cold prospects), and even those that are unlikely ever to buy, although perhaps they are likely to consume sales resources for other purposes (such as generating negotiating leverage with a competitor who already has the business “locked in”); this last category may be thought of as “red herrings”—companies likely to consume resources with no possibility of generating sales.

Matching engine 145 is a software module that attempts to match likely buyers with appropriate products and services. It takes, as inputs (from data storage module 160 or directly from the relevant software modules, as described above) data about potential buyers for a given category of product or service, along with those potential buyers' likelihood to buy information for the relevant category, and data about products and services within the relevant category. For instance, matching engine 145 could be used by a user (via user interface 150) to create a list of leads for products and services available from the user's company. Then, using a matching algorithm, potential buyers are matched with the most appropriate products and services, and returned to the user (via user interface 150), generally as a ranked list of prospects with assessments of the potential of each. Matching is done, according to a preferred embodiment, using an optimization algorithm (there are many well-known optimization algorithms in the art), with the objective being to optimize the degree of fit between buyers and proposed products or services. Thus one potential buyer, with a high ISIS Smart Grid Index score, but a moderate Likelihood to Buy rating, might be proposed as a potential buyer of a smart grid solution, but with a caveat that the time to likely purchase is extended (i.e., a “warm prospect”). On the other hand, a potential buyer with the same ISIS Smart Grid Index score and a moderate ISIS Energy Management Index score, and high likelihood to buy rating, might be proposed as a potential buyer of a mix of smart grid and energy management products (many of which interoperate or are closely related), and the client might be rated as a “hot prospect”. And a third potential buyer might have a high ISIS Smart Grid Index score, but might have been rated as a “red herring” by buyer analysis engine 140, and this potential buyer would be labeled as a “red herring”. In this situation, matching engine would suggest a strong effort to focus on the second customer (the “hot prospect”), while investing time in developing the first (the “warm prospect”), while the third customer (the “red herring”) would be presented as one in which no sales effort should be invested.

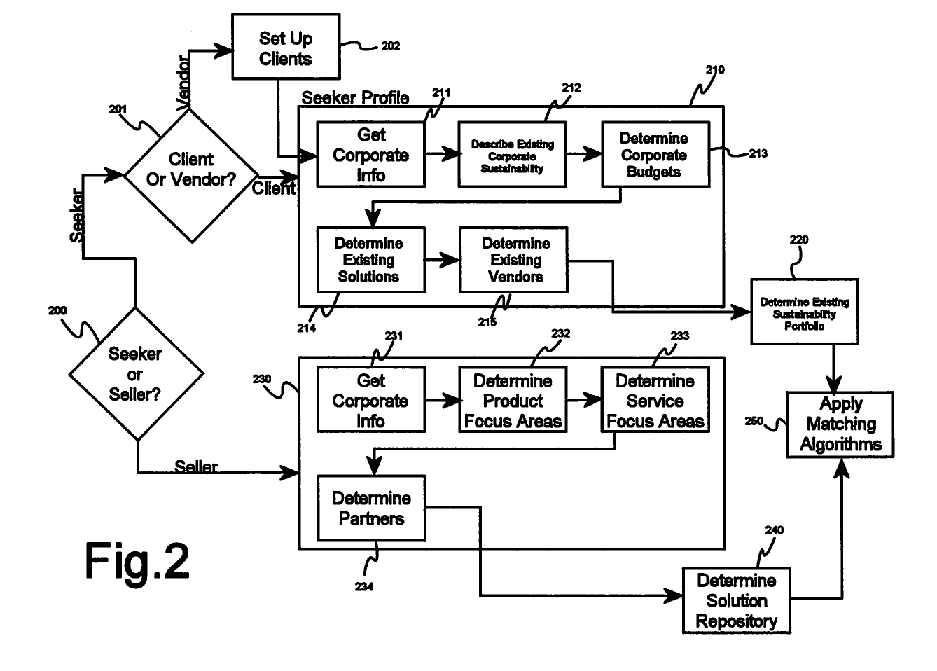

FIG. 2 provides an illustration of a high-level process flow showing how buyers (seekers) and sellers interact with systems 100 according to the invention. In a first step 200, a determination is made whether a new user is a seeker or a seller (a seeker is a potential buyer who is seeking relevant products or services to potentially buy, and who seeks the aid of a system according to the invention to identify appropriate products or services to consider for purchase to meet her needs). If the user is a seeker, a system 100 according to the invention determines in step 201 whether the seeker is a vendor or a client. A vendor is a person who, either on his own behalf or as a representative of an entity such as a reseller or other corporation, intends to help match buyers (clients) and sellers, typically obtaining some form of compensation (commission, referral fee, or the like) when transactions are successfully conducted based on his connecting of a buyer to a seller. A client is one who, either individually or more typically as a representative of a company, contemplates entering into a transaction as a buyer of sustainability products or services (or complex products or services of another type, where the invention is carried out with respect to other types of complex products and services, such as insurance). If the user is a vendor, then in step 202 the vendor uses user interface 150 to set up a plurality of clients (without the clients' necessarily being involved at all). After setting up clients, the vendor can optionally establish seeker profiles in step 210, or the vendor may ask clients to establish their own profiles in step 210. If the user is a client, then the user proceed to setting up a seeker profile in step 210; thus whether a client is set up by a vendor or enters directly, a key preliminary step is establishing a seeker profile in step 210, which step is the same whether an independent client, a client with a reseller, or a vendor or reseller acting directly, carries out the tasks.

Establishing seeker profiles 210 is carried out in a series of substeps which, while shown in a particular, may in various embodiments be carried out in any order. In step 211, basic corporate information on the seeker being profiled (hereinafter simply referred to as “the seeker”) is entered. Such information as corporate name, address, billing information, and the like, is provided. Moreover, information concerning the number, kind, and location of various corporate facilities may be provided, or information may be entered that identifies a geographic scope of the seeker's company (because this can be used to determine regulatory needs, suitability for national scale services, and so forth). In step 212, detailed information is provided to describe existing corporate sustainability programs (existing programs and new initiatives). This step may be conducted as an interview, an automated survey, a fillable web form, or even a mobile application that prompts a sales person or the seeker directly to walk through a series of questions. In many cases, pull down lists of possible answers to questions like “Which of the following typical sustainability programs are currently in use or planned at your company?” Such pull down lists make it easier to normalize data (since there won't be spelling variations, for instance, and since a standardized semantics would naturally be used), and also tend to help jog the memories or thinking of the seeker, who may not know, or be able to bring readily to mind, all the sustainability programs that might be in use in her company. In step 213, information pertaining to corporate budgets is obtained. While normally corporate budgets are a matter of great sensitivity, and typically they aren't shared with external sales people, it is a benefit of the present invention that, when a third party system 100 that adds value for both buyer and seller is involved (and that controls access to information), it may be desirable for seekers to share budgetary and other “likelihood to buy” information more readily and fully. In step 214, seekers are prompted (again, often with pull down lists) to provide as much information as possible about existing sustainability solutions being used by her company. And, in step 215, the same approach is used to obtain information about particular vendors whose products or services are currently in use, or planned for near term use, in the seeker's company. Clearly, the more information provided by the seeker in step 210, the better able system 100 will be able to accurately determine the most appropriate products and services to recommend, and as users continue to find value in system 100, they are able to augment or correct previously entered information by repeating step 210 as many times as desired. Keeping in mind that, according to preferred embodiments of the invention, extensive use is made of third party data sources 112 and automated data collection 113, it should be clear that, over time, a very comprehensive profile of medium and large corporations may be established according to the invention. Furthermore, as each seeker user and other source adds data to a seeker profile, data can be cross-checked and factual conflicts can be identified. These may be flagged and sent to users within system 100 or associated with a vendor, who then can resolve the conflict and correct any mistaken information. Thus the accuracy of profiles obtained by system 100 and stored in data storage module 160 should continually improve, generally making it more attractive over time to provide more (and more accurate) information to system 100 in order to get better recommendations from the invention. Once a seeker has completed a seeker profile in step 210, in step 220 the system 100 of the invention determines the seeker's company's existing sustainability portfolio (and computes various attribute indices and likelihood to buy values).

Considering now the case when a user is a seller, the user completes (or updates) a seller profile in step 230. Like step 210, step 230 is composed of several substeps that may be performed in any order. As with a seeker, in step 231 corporate information is provided. Again, basic corporate information such as name, primary location, and type can be provided, but also more detailed information such as geographic scope of sales, resellers and their geographic range, and so forth. In step 232, product focus areas are determined, which is a combination of explicit data entry as well as product categorization using product/service categorizer 135. Similarly, in step 233, services focus areas are determined, again using a combination of explicit data entry (such as a list of services provided) and through the use of product/service categorizer 135. In step 234 partners are determined, typically by direct data entry (user provides a list of resellers and other partners, and optionally provides corporate overview information, if it is not already in the system, for one or more of the partners listed. This collective information (collected in seller profile creation step 230) is then used to determine the contents of the seller's solution repository in step 240.

When a plurality of seekers and sellers have created profiles, and incrementally enriched those profiles in subsequent iterations through steps 210 and 230 respectively, and when a plurality of seeker portfolios and needs and a plurality of seller solution portfolios have been created, then in step 250 matching algorithms are applied by matching engine 145 to determine an optimal or near-optimal, or at least a desirable (optimization is not always necessary according to the invention) list of proposed buyer/seller pairings, and particular solutions associated therewith (that is, solutions that a particular seller has that a particular buyer needs and is likely to buy).

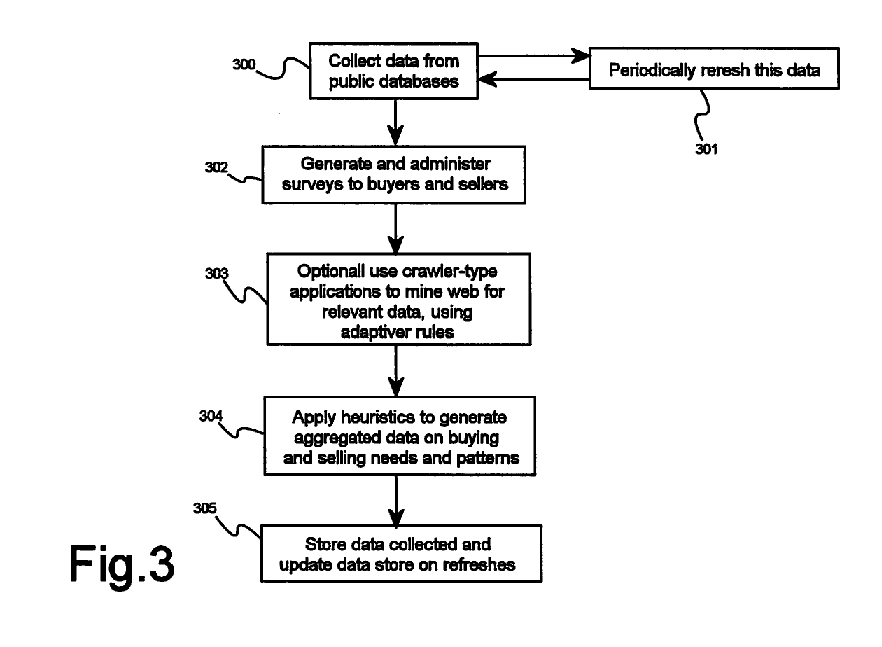

FIG. 3 illustrates a method, according to an embodiment of the invention, for automatically collecting and analyzing data to determine indices reflecting underlying attributes of a business, according to the invention. In step 300, data is collected from a plurality of public data sources or databases, and optionally from a plurality of private data sources as well. This data may be periodically refreshed in step 301, either automatically at predetermined intervals, or in response to a triggering event, or in response to a user request. In step 302, one or more surveys are created and administered to a plurality of buyers and sellers, either through the use of online surveys, automated phone surveys, or in person interviews. Data can also be collected by field personnel such as sales people while visiting prospective buyers, and entered into data storage module 160 manually by those personnel. In optional step 303, one or more crawler-type automated data collectors 113 is used to mine the web for relevant data, using a set of adaptive rules to continually improve data collection effectiveness. In step 304, one or more heuristics or rule sets is applied to the data collected in steps 300-303 to generate aggregated data on buying and selling needs and patterns. The results (collected raw data and aggregated data) are stored in step 305 in data storage module 160, and when data is refreshed the corresponding data in data storage module 160 is modified.

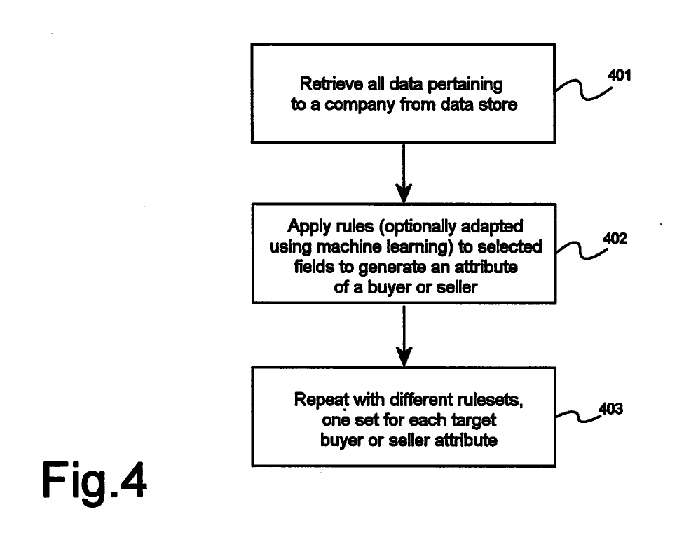

FIG. 4 illustrates a method, according to an embodiment of the invention, for summarizing detailed data about a business into a plurality of binary or numeric attributes, according to the invention. In step 400, all previously collected data pertaining to a particular company is retrieved from data storage module 160. In step 401, one or more rules are applied to a plurality of selected retrieved data fields to generate an attribute of a buyer or a seller. In some embodiments of the invention, the rules used to generate attributes are adaptive, and change in response to the use of one or more machine learning algorithms. For example, when an attribute indicates a high need for a certain product, and later sales activity determines that the need was not real, then the rule or rules that generated the attribute could be automatically modified to reduce the likelihood of similar errors in future attribute generation events.

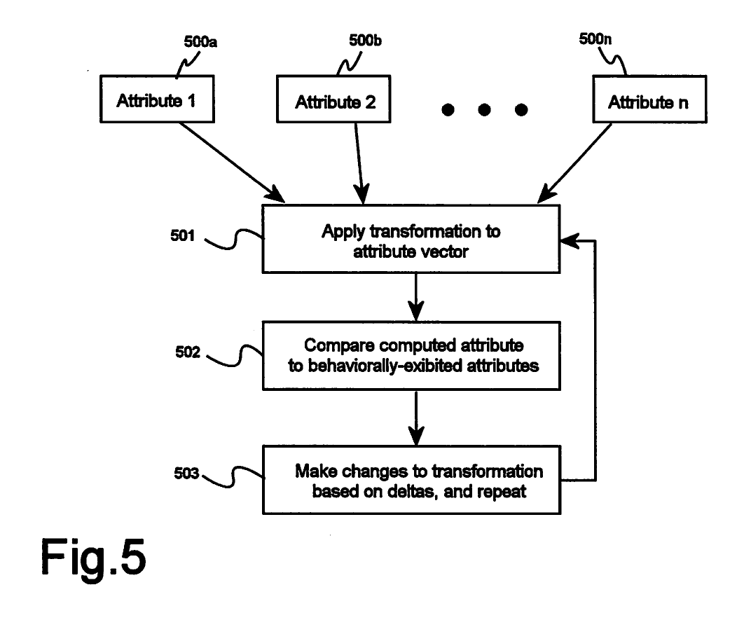

FIG. 5 illustrates a method, according to an embodiment of the invention, for dynamically creating a weighted relational transformation that, operating on summary data, creates one or more indices tied to particular high-level business attributes, according to the invention. In preparatory steps 500a, 500b, 500c, a plurality of binary or numerical attributes (Attribute 1, Attribute 2, and so on through Attribute n, as shown in FIG. 5) is collected (typically from data storage module 160), and fed as inputs into step 501. In step 501, the inputs are treated as an attribute vector of values. A weighted relational transformation (generally, a transformation matrix in which matrix elements capture relationships between input vector elements and weights to be accorded to each pair of elements) is applied to the input attribute vector, as described in detail above. In step 502, generally at a subsequent time, computed attributes are compared to an actual behaviorally exhibited attribute (that is, the predicted value is compared to the actual value determined by observing behavior of a relevant buyer or seller). In step 503 changes are optionally made, based on the comparison made in step 502, to the transformation matrix used in step 501. Future iterations of the process illustrated in FIG. 5 would then use the newly modified transformation matrix coefficients until and unless a future iteration of step 502 indicates a need for further adjustment.

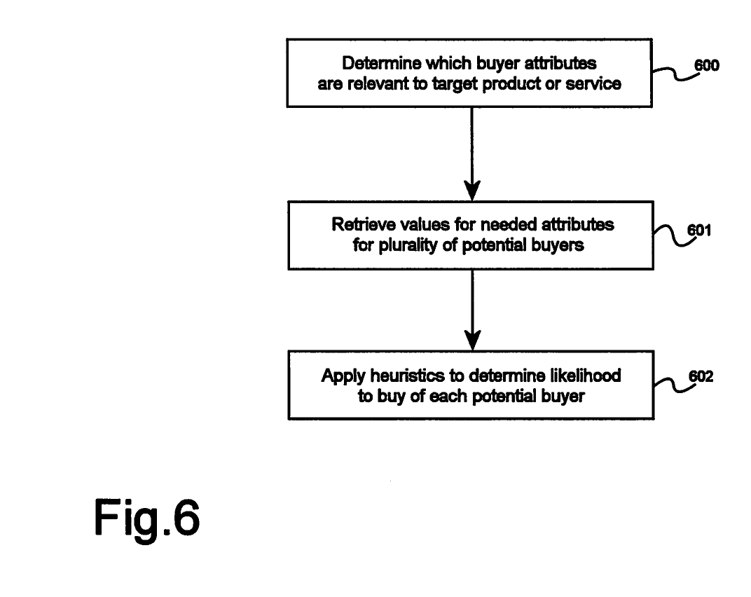

FIG. 6 illustrates a method, according to an embodiment of the invention, for determining a likelihood to buy based on weighted relational transforms of summary data, according to the invention. In step 600, a user (typically but not necessarily using user interface 150) or system 100 determines which buyer attributes are relevant to a particular target product or service for which a likelihood to buy is to be determined. In step 601, relevant attribute values for the selected attributes are retrieved from data storage module 160 for a plurality of potential buyers. Attribute index generator 126 or buyer analysis engine 140 may have generated the attributes retrieved. In step 602, one or more heuristics or rule sets are applied to the retrieved attributes to determine a likelihood to buy for each potential buyer.

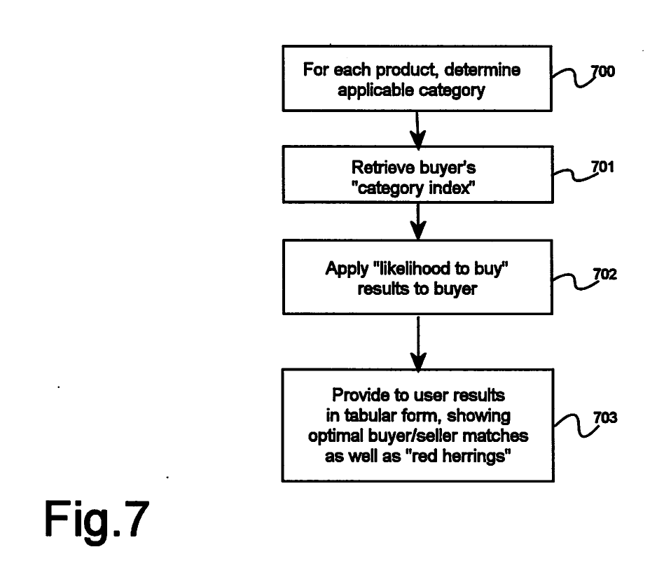

FIG. 7 illustrates a method, according to an embodiment of the invention, for matching potential buyers and capable sellers for particular categories of products or services, according to the invention. In step 700, an applicable category is determined for each product to be considered; this step is generally but not necessarily carried out in product/service categorizer 135. In step 701, each potential buyer's category index is retrieved from data storage module 160. Attribute index generator 126 generates attribute indices, and indices are selected based on the categorization made in step 701. For example, if a product to be considered was categorized as a “smart grid solution” in step 701 (keeping in mind that it could be categorized into multiple categories), then each potential buyer's ISIS Smart Grid Index score is retrieved in step 701. Then, in step 702, for each product/buyer pair, a likelihood to buy result is applied. It is important to note that “likelihood to buy” scores are generally computed for a given buyer with respect to a given product/service category. Finally, in step 703 system 100 provides results via user interface 150 to a user, generally in tabular form, showing optimal buyer/product category matches and optionally also buyer/seller matches. In addition, indications are provided of situations where a buyer's need (attribute index score) is high, but where the opportunity is rated as a “red herring”, for the purpose of avoiding sales investment in an apparently attractive opportunity that, for one of many possible reasons (some of which are described above), is almost certainly not going to lead to a sale.

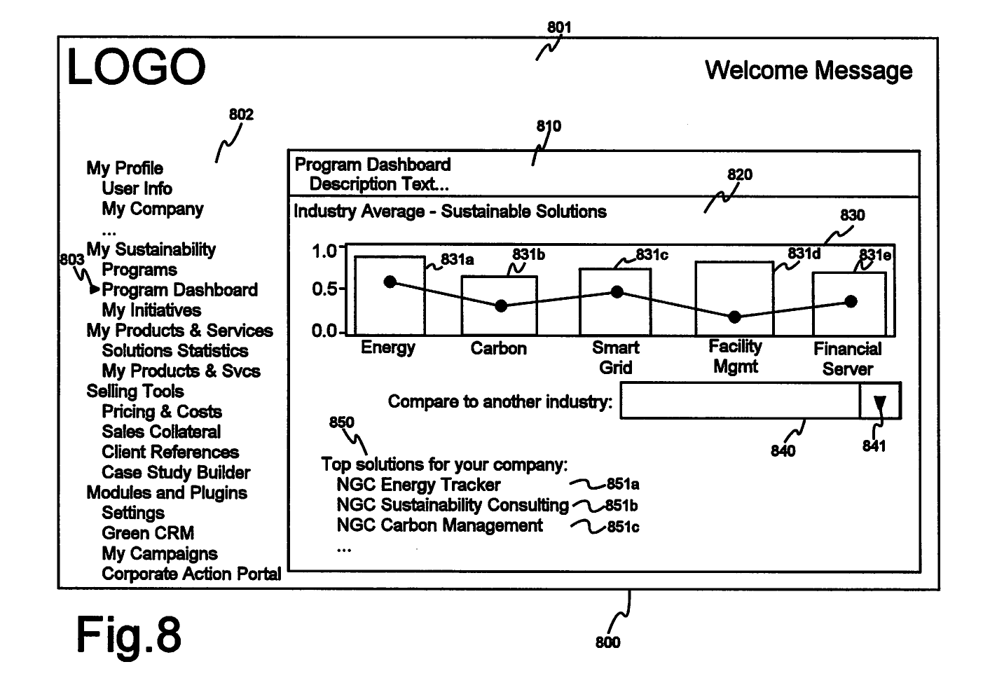

FIG. 8 is an illustration of dashboard page 800 of user interface 150 according to an embodiment of the invention. Generally dashboard 800 is displayed within a browser window, although it is certainly possible to use a dedicated client or a mobile application for dashboard 800, according to the invention. As is true with dashboards generally, dashboard 800 is intended to provide a high-level summary of a company's situation; in this case, the focus is on providing a “program dashboard” to provide a top-level view of the status of all of a company's sustainability programs. Of course, as mentioned before, sustainability programs is only an exemplary embodiment, and it is anticipated that dashboards to cover, for example, various market segments for an insurance company. Dashboard 800 comprises a header 801 that typically contains corporate logos and general information such as a welcome message, and a navigation sidebar 802 that provides a series of navigation links to various functional elements of user interface 150. In FIG. 8, a navigation link 803 for “Program Dashboard” is marked by an icon (in this case, a triangle) to indicate the current location of a user for ease of navigation. Dashboard 800 further comprises a frame header 810 and main content frame 820, which collectively provide the active region of user interface 150 at any given moment. Frame header 810 typically has a title corresponding to the applicable navigation link 803 (in this case, “Program Dashboard”), and often some high-level descriptive text informing a user of the purpose of the particular content element. Main content frame 820 comprises, in an exemplary dashboard embodiment shown, a graphics element 830 which presents a graphical view of the subject company's performance relative to other participants in its industry (different industry comparisons can be made by using pull down list 840 and selection button 841 to select a different industry). In the example shown, rectangles 831a-e illustrate industry averages for an ISIS Sustainability Index, and shows, via the dots and connecting curve, how the subject company rates relative to the industry as a whole. Main content frame 820 also comprises a supplemental data region 850, used in this example to highlight top sustainability solutions recommended by system 100 for the subject company (recommendations coming, as described above, from matching engine 145). In the illustrated exemplary embodiment, the subject company is advised to consider three solutions from a company called NGC—NGC Energy Tracker 851a, NGC Sustainability Consulting 851b, and NGC Carbon Management 851c.

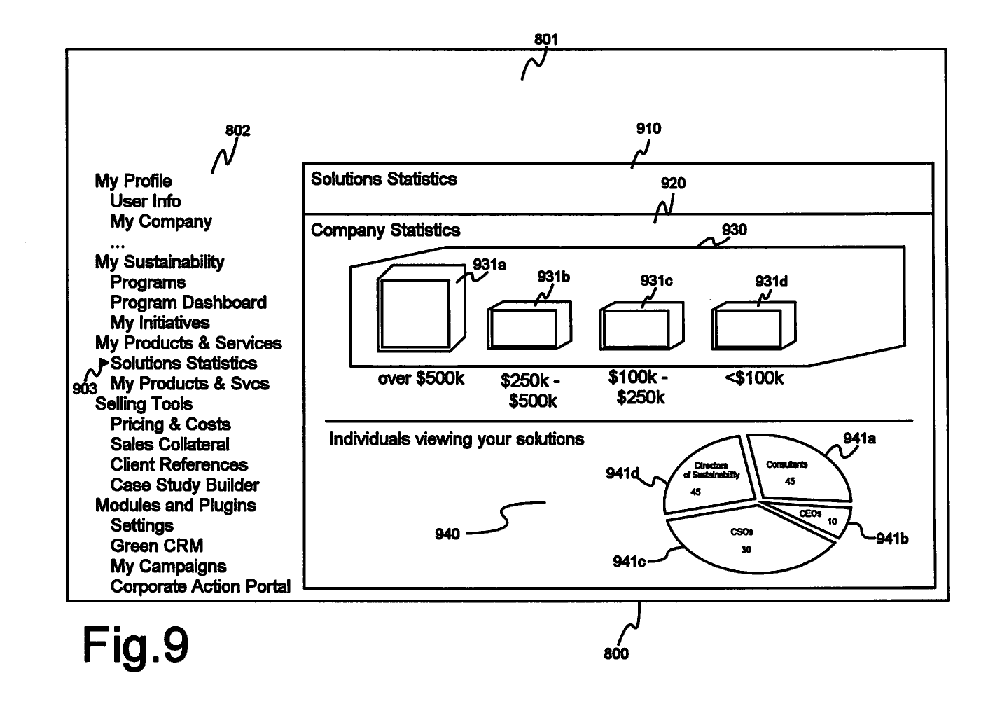

FIG. 9 is an illustration of a solution statistics page of a user interface according to an embodiment of the invention. Keeping with an exemplary general layout for user interface 150, header 801 and navigation sidebar 802 are retained, although in FIG. 9 a navigation link 903 for “Solutions Statistics” is highlighted by the “you are here” icon described with reference to FIG. 8. Also, as with the program dashboard example, frame header 910 contains a title that corresponds to the selected navigation link (“Solutions Statistics”). Main content frame 920 comprises, in this exemplary embodiment, a first graphical element 930 and a second graphical element 940. The first graphical element 930 comprises a set of three-dimensional bar chart elements 931a-d corresponding to percentages of the subject company's clients that correspond to various client revenue segments (over $500K, $250-$500K, and so forth). In various embodiments, other relevant company statistics are displayed in graphical views, and the invention should not be considered as being limited to the particular statistics or graphical elements shown. The second graphical element 940 is, in this embodiment, a pie chart showing a distribution of roles among the various individuals who viewed one or more solutions provided by the company regarding whom the statistics were generated. For example, pie chart element 941d illustrates that 45 out of 130 viewers of the subject company's solutions were directors of sustainability, and 10 were CEOs of other companies (hopefully prospective buying companies).

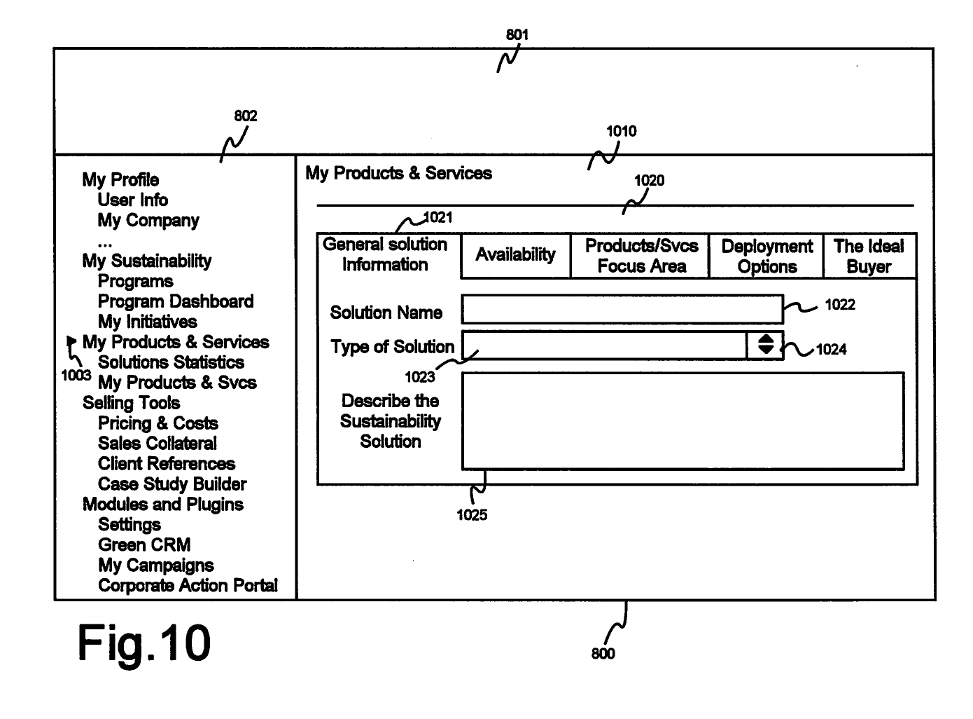

FIG. 10 is an illustration of a products page of a user interface according to an embodiment of the invention. As illustrated, navigation link 1003 has been selected by a user, leading to the display shown of a “My Products and Services” page with a frame header 1010 and a main content frame 1020 comprising a set of tabs of which one tab 1021, labeled General Solution Information, is selected. Corresponding with the topic of general solution information, main content frame 1020 has a text entry box 1022 which a user can use to type in a solution name when creating a new solution. If a solution exists already, after typing the first few letters of the solution's name, a user can be shown a pull down list which lists all potentially matching solution names, to allow a shorthand for situations where a solution already has been created and a user wishes to edit information pertaining to the solution. A solution type data entry box 1023 is also provided, with a pull down menu button 1024 provided so that users can quickly select an appropriate solution type (generally these correspond to the categories configured for use throughout system 100, for example including “smart grid”, “energy management”, “general sustainability”, and so forth, for sustainability-based embodiments). Finally a larger, multi-line text entry box 1025 is provided for a user to enter or edit text describing the solution whose name is entered in text box 1022. Other tabs are provided for accessing data entry frames where more detailed information pertaining to the selected solution can be provided or edited by the user. In the exemplary embodiment shown in FIG. 10, tabs include “Availability”, “Product/Services Focus Area”, “Deployment Options”, and “The Ideal Buyer”. These can be used to enter or edit information concerning the respective topics, said information being added to data storage module 160 and being used by product/service categorizer 135 to determine one or more categories to which assign the selected solution. Furthermore, data entered in, for example, the “The Ideal Buyer” tab can be stored in data storage module 160 and used by matching engine 145 to help make optimal pairings between buyers and products or services, as described above.

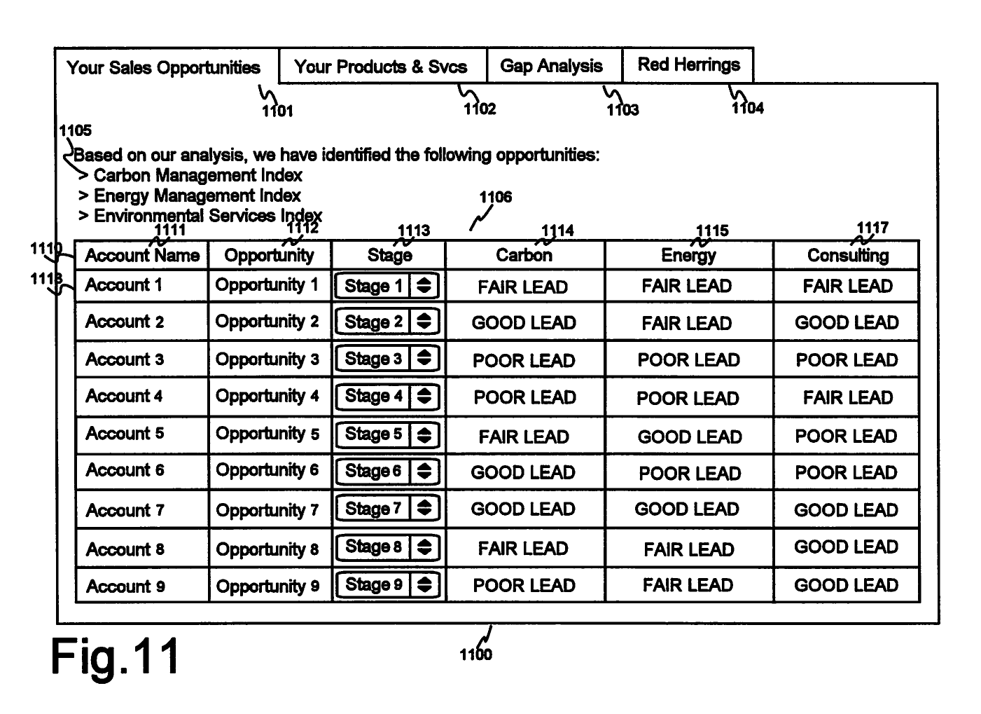

FIG. 11 is an illustration of a sales opportunities tab 1101 of a frame 1100 of user interface 150 according to an embodiment of the invention. Frame 1100 is, in some embodiments, a web browser window, while in other embodiments frame 1100 is contained within a larger application such as, for example, an extensible customer relationship management (CRM) system such as Salesforce.com™. Frame 1100 comprises four tabs in the illustrated embodiment (different combinations of these and other tabs are of course possible; the illustrated arrangement is meant to be exemplary in nature and should not be taken as limiting the scope of the invention beyond that of the claims below). The tabs include “Your Sales Opportunities” 1101, “Your Products and Services” 1102, “Gap Analysis” 1103, and “Red Herrings” 1104. In FIG. 11, tab 1101 is active, and comprises a region 1105 of textual information containing, in the example shown, a list of opportunities identified by system 100 as being of particular relevance to the user's organization. Note that the tabs shown are for sellers of sustainability solutions, and represent a series of logically related data presentation elements to assist sales and marketing personnel in accelerating their ability to sell and deliver meaningful sustainability solutions to new and existing clients (customers). In the illustrated example, system 101 has identified (using matching engine 145) three primary areas of sales opportunity (Carbon Management, Energy Management, and Environmental Services). This selection is based on the strengths and categorizations of the seller's products and services, and the availability of prospective buyers identified by system 100 as having corresponding needs.

Tab 1101 further comprises a table 1110 consisting of several rows 1118, each of which represents a particular buyer (account)/opportunity pairing that has been determined by matching engine 145 to represent high sales opportunities for the given user. Note that in most embodiments a vertical scroll bar may be added when more than one screen's worth of recommendations are available, enabling a user to scroll down and back to view all recommended account/opportunity pairs. Table 1110 is comprised of a plurality of columns for display of data, including for example, in the embodiment illustrated in FIG. 11:
Account Name 1111—a name by which different buyers may be referred to;
Opportunity 1112—a short name representing a particular product or service selling opportunity for the particular buyer/account (for example, “corporate-wide energy management solution”);
Stage 1113—each account/opportunity pair (that is, each row) is assessed by system 100 as being in a certain stage, selected or prepopulated from an enumerated list accessible via a pull down menu list for each cell in the column (examples of real stages include “solution exploration”, “RFP”, “feasibility”, “contract negotiations”, “pilot”, and so forth);
One or more opportunity categories, such as here Carbon 1114, Energy 1115, and Consulting 1116—each cell in these columns (of which there could be one, two, three, or more) provides a high-level assessment by system 100 of the quality of the opportunity from the perspective of the seller (for instance, “good lead”, “fair lead”, “poor lead”, and so forth).
   The rows in table 1110 are typically arranged in a ranked order by system 100, but need not necessarily be so arranged (they could, for instance, be alphabetically arranged, or sorted by region, or whatever arrangement serves a selling user most effectively).

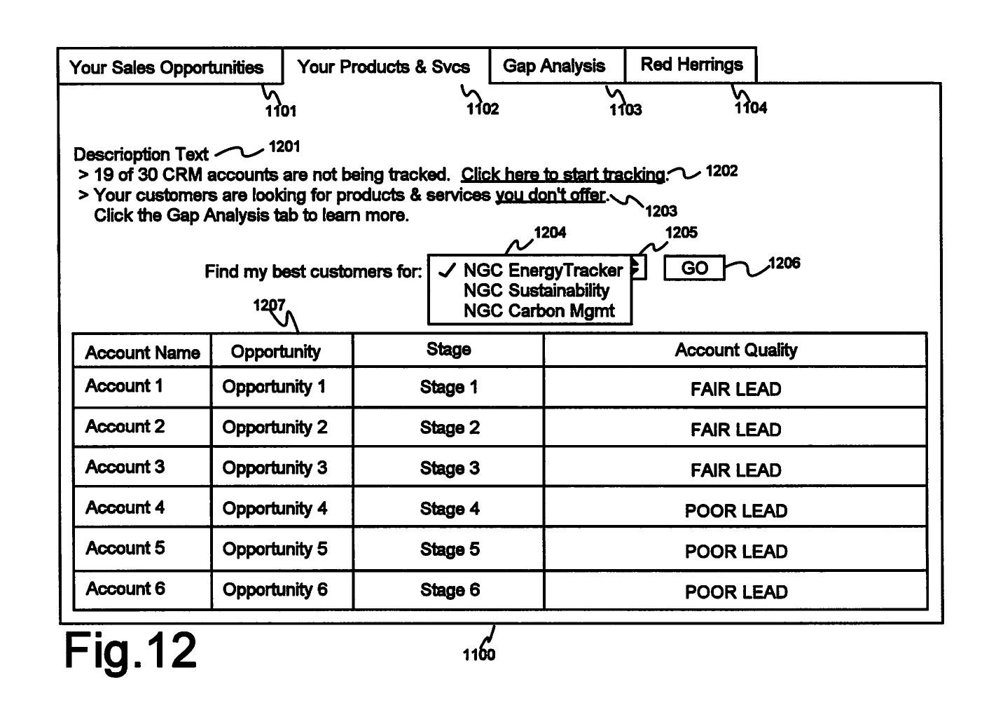

FIG. 12 is an illustration of a products tab 1102 of a frame 1100 of user interface 150 according to an embodiment of the invention. Tab 1102 comprises a text header region 1201, and a table 1207 for displaying sales opportunities specific to a selected product or service (that is, a selected solution). In some embodiments, text region 1201 contains seller-specific alerts advising the seller of problems and opportunities that may require the seller's attention. For example, in the illustrated embodiment an alert advises a seller that 19 of 30 CRM accounts are not currently tracked by system 100, and provides a link 1202 to start tracking those CRM accounts (generally by proceeding directly to a seeker profile editing step 210 in which CRM data is prepopulated (typically, a CRM system will have much of the data required by step 211—edit corporate background—and could prepopulate the profile so that a selling user would be able to minimize effort spent setting up tracking for the untracked accounts). Similarly, when appropriate (that is, when matching engine 145 identifies known CRM accounts whose highest needs indices do not correspond to products or services currently provided by the seller), an alert can be provided in text region 1201 informing the seller that customers already present in the CRM system have need of solutions the seller does not offer, and provides a link 1203 to a screen which presents information on these customers and their unaddressed needs. This is a very valuable function of the present invention, as it helps product managers, for example, identify real business opportunities where product development efforts could be effectively undertaken, and it also highlights areas where immediate partnership opportunities (specifically, partnering with non-competitive companies that do provide the solutions for which there is unmet demand). Finally, in FIG. 12 text region 1201 also comprises a selection box in which a seller can select one from among a plurality of solutions that are provided by the seller's company (possibly in conjunction with partners), using selection box 1204, which optionally includes a pull down list activation button 1205, and then populating table 1207 by pressing a button 1206 (in this embodiment, labeled “GO”). This combination of user interface elements allows a seller to select a specific solution and then to identify the most promising leads for the solution (and to review information regarding the customer opportunities in table 1207). Table 1207 is populated after selection via selection box 1204 with rows of data that comprise, for example, account name, opportunity name, buyer stage, and account quality (all of which were described with reference to FIG. 11).

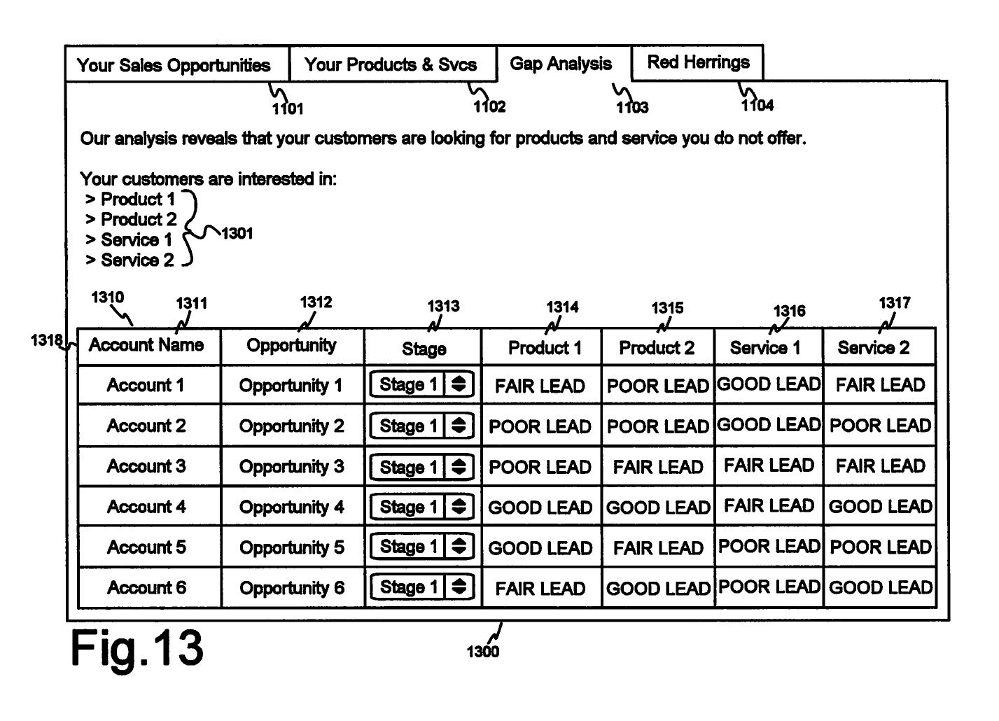

FIG. 13 is an illustration of a gap analysis tab 1103 of a frame 1300 of user interface 150 according to an embodiment of the invention, which is an embodiment of what can be displayed when link 1203 is selected (alternatively, tab 1203 could be selected directly). Frame 1300 in some embodiments comprises a list 1301 of products and/or services which known customers demand, but which are not currently provided by the seller's company or its partners (and therefore which represents opportunities for new revenues, and also threats where a competitor who does offer the desired products and/or services could step in and “steal” the customer away from the seller). Frame 1300 further comprises a table 1310 which comprises a plurality of rows 1318 of data pertaining to each account/unmet need pair identified. Each row can, according to the embodiment, comprise columns for Account Name 1311, Opportunity Name 1312, Opportunity Stage 1313, and a plurality of products and services (specifically, the ones listed in list 1301), in which product/service columns a brief summary of the quality of the lead is presented.

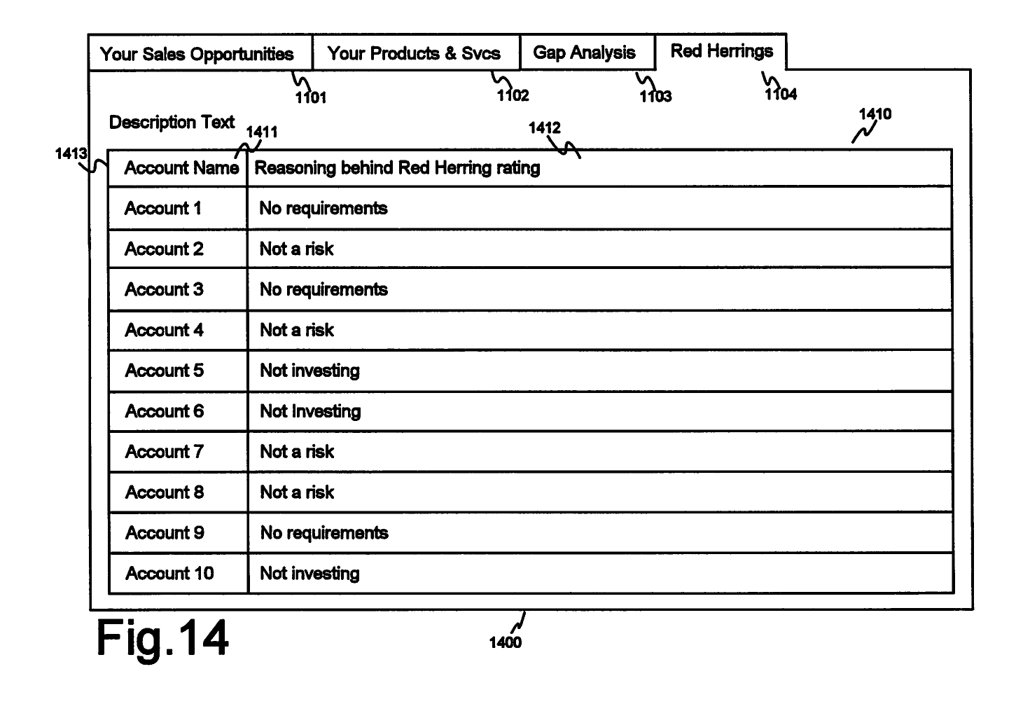

FIG. 14 is an illustration of a “red herrings” tab 1104 of a frame 1400 of user interface 150 according to an embodiment of the invention. Frame 1400 comprises a short title and a table 1410 containing rows 1413 of data for each opportunity rated as a “red herring” (very low probability of sale despite a high buyer attribute index suggesting a strong need on the part of the applicable buyer). Each row 1413 comprises, for example, an account name 1411 and a brief reason behind the “red herring” rating assigned to the account. In some cases an extra column labeled “Opportunity Name” can be provided, and “red herring” status is then applicable to a plurality of specific account/product pairings. Reasons for “red herring” rating assignment can include, but are not limited to, reasons such as “client has no well-defined requirements”, “client does not see the area as representing a real business risk”, “client not investing in the area”, and the like.

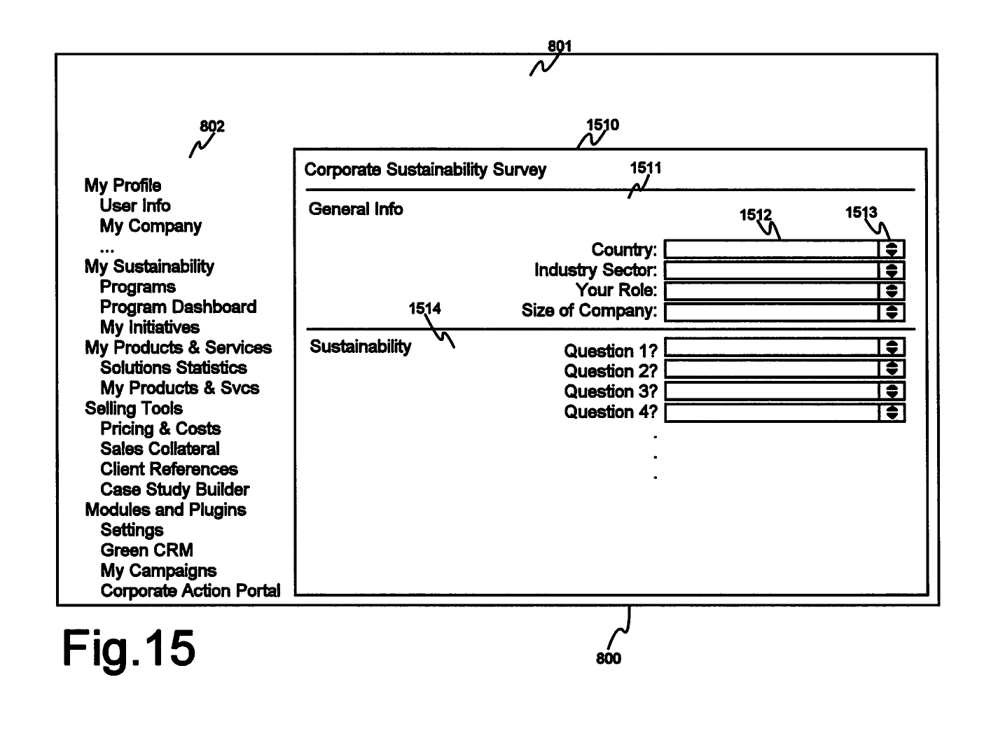

FIG. 15 is an illustration of a corporate sustainability survey page of a user interface according to an embodiment of the invention. The page comprises a browser or frame 800, a navigation sidebar 802, a main content header 801, and a survey frame 1510. Survey frame 1510 further comprises a data entry region 1511 for general information and at least one solution category-specific survey question region 1514. Data entry region 1511 comprises a plurality of general data entry boxes 1512, each generally provided with a pull down list activation button 1513. Examples of data gathered in general information data entry region 1511 include country, company size, and industry sector for the survey recipient's company, and a role identification element for the survey recipient to indicate her role in her company (for example, Director of Sustainability, Facilities Director/Manager, CEO, Energy Conservation Manager, and so forth). Category-specific survey question region 1514 comprises a plurality of questions pertaining to the specific category (for example, as shown in FIG. 15, Sustainability), each of which has a text entry box and a pull down list button for responding to the question (in many cases, it will be desirable to only accept prepopulated pull down list items as answers, as this will ensure the ability to draw statistical inferences from the surveys).

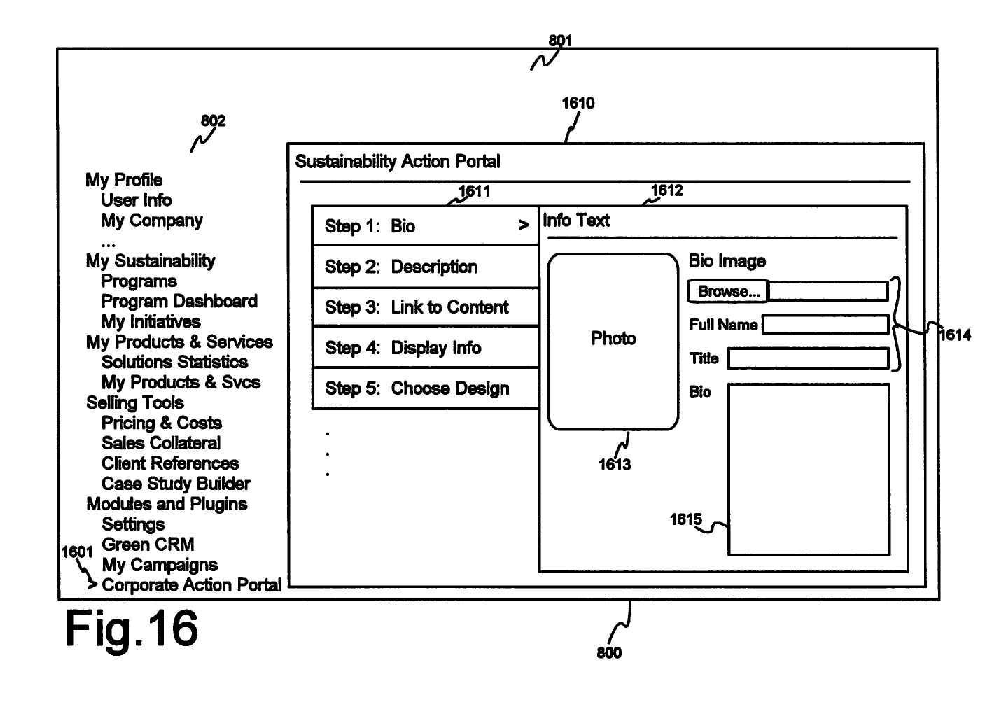

FIG. 16 is an illustration of a sustainability action portal page of a user interface according to an embodiment of the invention. The page comprises a browser window or frame 800, which itself comprises a main content header 801, navigation sidebar 802 (with navigation link 1601 for “Corporate Action Portal” selected in the embodiment illustrated in FIG. 16), and a frame 1610 comprising a corporate action portal (in the illustrated example, a sustainability action portal). Frame 1610 comprises a sequencing sidebar 1611 outlining action steps to be taken, and an inner frame 1612 which changes as each action step is selected in sequencing sidebar 1611. In the example illustrated in FIG. 16, an action step labeled “Step 1: Bio” has been selected and is displayed in inner frame 1612. While each action step will comprise different elements suitable to its purpose, FIG. 16 illustrates an exemplary embodiment of an action step to clearly illustrate the concept. In order to build a bio for inclusion on a corporate portal, a photo 1613 can be uploaded by using photo location and editing tools 1614, and a brief bio can be typed into text entry box 1615. After these items (photo and bio) are entered, they may at any future time be edited using the same inner frame 1612. While not shown, typically there would be “Save”, “Upload”, and “Cancel” buttons, as are commonly provided on profile editing pages and as if well understood in the art.

All of the embodiments outlined in this disclosure are exemplary in nature and should not be construed as limitations of the invention except as claimed below.

1. A system for matching potential buyers and sellers of complex offers, comprising:
a plurality of data collection software modules operating on one or more computers and each connected to at least one packet-based data network and adapted to collect data pertaining to a plurality of potential buyers or sellers of complex offers;
a summary data generator software module operating on a computer and connected via a data network to a database;
an attribute index generator software module operating on a computer and connected via a data network to the database;
a categorization software module operating on a computer and connected via a data network to the database;
a buyer analysis engine software module operating on a computer and connected via a data network to the database;
an analysis engine software module operating on a computer and connected via a data network to the database; and
a matching engine software module operating on a computer and connected via a data network to the database;
wherein data collected by the data collection software modules is stored in the database and is used by the summary data generator software module to generate a plurality of summary data elements pertaining to a potential buyer or seller of a complex offer, and the plurality of summary data elements is stored in the database and used by the attribute index generator software module to generate attribute indices each based on at least two summary data elements using a weighted relational algorithm, and at least some data collected by the data collection devices is used by the buyer analysis engine software module to determine at least a probability that a buyer will buy a specific complex offer; and
wherein the matching engine software module uses an optimization algorithm to determine an optimal matching of potential buyers and complex offers based at least in part on a plurality of attribute indices and a likelihood to buy for each potential pair of offers and potential buyers.

2. A system for matching potential buyers and sellers of complex offers, comprising:
a summary data generator software module operating on a computer and connected via a data network to a database;
an attribute index generator software module operating on a computer and connected via a data network to the database;
a categorization software module operating on a computer and connected via a data network to the database;
a buyer analysis engine software module operating on a computer and connected via a data network to the database;
an analysis engine software module operating on a computer and connected via a data network to the database; and
a matching engine software module operating on a computer and connected via a data network to the database;
wherein data pertaining to potential buyers or sellers of a complex offer is retrieved from the database and used by the summary data generator software module to generate a plurality of summary data elements pertaining to a potential buyer or seller of a complex offer, and the plurality of summary data elements is used by the attribute index generator software module to generate attribute indices each based on at least two summary data elements using a weighted relational algorithm, and at least some data collected by the data collection devices is used by the buyer analysis engine software module to determine at least a probability that a buyer will buy a specific complex offer; and
wherein the matching engine software module uses an optimization algorithm to determine an optimal matching of potential buyers or sellers and complex offers based at least in part on a plurality of attribute indices and a likelihood to buy or sell for each potential pair of offers and potential buyers or sellers.

3. the system of claim 2 wherein attribute indices are determined using a weighted relational algorithm.

4. The system of claim 2 wherein the complex offers are products or services that pertain to sustainability of businesses.

5. A method of matching potential buyers and sellers of complex offers, the method comprising the steps of:
(a) collecting data pertaining to a plurality of potential buyers or sellers of complex offers or to the complex offers themselves;
(b) using the collected data to generate a plurality of summary data elements pertaining to a potential buyer or seller of a complex offer,
(c) using a plurality of summary data elements to generate a plurality of attribute indices each based on at least two summary data elements;
(d) using a plurality of attribute indices to determine at least a probability that a buyer will buy a specific complex offer; and
(e) computing, in a matching engine software module operating on a computer and using an optimization algorithm, an optimal matching of potential buyers or sellers of complex offers and a particular set of complex offers based at least in part on a plurality of attribute indices and a likelihood to transact for each pair of offers and potential buyers or sellers.

6. The method of claim 5 wherein attribute indices are determined using a weighted relational algorithm.

7. The method of claim 5 wherein the complex offers are products or services that pertain to sustainability of businesses.
